(19) United States
(12) Patent Application Publication
(10) Pub. No.: US 2006/0193144 A1
(43) Pub. Date: Aug. 31, 2006

(54) Side flashing lamp

(76) Inventors: Markus Braeutigam, Immelborn (DE); Frank Gotthard, Goettingen (DE); Martina Schwanz, Creuzburg (DE); Daniel Matthie, Eisenach (DE); Aliaksandr Makarav, Eisenach (DE)

Correspondence Address: THE BILICKI LAW FIRM, PC, 1285 North Main Street, JAMESTOWN, NY, 14701, US

(21) Appl. No.: 11/280,079

(22) Filed: Nov. 15, 2005

(30) Foreign Application Priority Data
Nov. 15, 2004 (DE) 10 2004 055 015.8

(51) Int. Cl. B60Q 1/26

(52) U.S. Cl. 362/493

(57) ABSTRACT

A side flashing lamp (1) for an external rear view mirror includes a lamp housing (2) with a light exit opening (3) extending from the vehicle side approximately horizontal towards the outside. At least one light guide (6, 7) extends over the light exit opening. The light of a light source (10, 11) is coupled into the vehicle end (8, 9) of the light guide and is propagated in the longitudinal direction. The portion of light arriving at the opposite end (12, 13) is emitted inclinedly rearwardly with respect to the direction of travel. To expand the functionality the at least one light guide has on its rear side a plurality of deflection structures (15) which are arranged distributed over its length and which deflect the light incident thereon in such a way that it issues through the front side of the light guide in which there is provided a plurality of optically active structures (17) which are arranged distributed over the length of the light guide and which emit a portion of the issuing light into an angular region (S₂-S₃) extending transversely with respect to the direction of travel.

The invention relates to a side flashing lamp of the kind set forth in the classifying portion of claim 1.

A side flashing lamp of that kind is known from EP 1 195 296. It includes at least one bar-shaped light guide which in the installed condition extends approximately horizontally over the light exit opening and in that arrangement is adapted to the curvature of the external mirror cover cap. The light of a light emitting diode is coupled into the vehicle end of the light guide so that the light is propagated in the longitudinal direction thereof and arrives almost completely at the opposite end where it is emitted inclinedly rearwardly with respect to the direction of travel into the spatial region which is laid down by statutory requirements.

That known arrangement is based on the premise that comparatively weak light emitting diodes are used, the light of which must be passed almost completely to the coupling-out end of the light guide in order to achieve the level of brightness required by statute in the emission region.

That known vehicle lamp therefore has only one single function, namely that of a side flashing lamp.

In comparison the object of the present invention is to develop a side flashing lamp of the kind set forth in the opening part of this specification in such a way that it can perform more than just one single function.

To attain that object the invention provides the features which are set forth in claim 1.

That configuration is based on the realisation that, by virtue of the fact that very bright light emitting diodes have become available in the meantime, it is no longer necessary for almost all the light which is coupled into the bar-shaped light guide to be passed to the opposite end in order there to achieve the required level of emission brightness.

Rather, with those modern light emitting diodes it is readily possible for portions of the light which is being propagated in the light guide to be progressively deflected by means of deflection structures arranged in a distributed relationship over the length of the light guide, in such a way that they issue through its front side which is towards the light-transmitting cover of the vehicle lamp without having lost an excessive amount of brightness which can be emitted, at the coupling-out end.

Then in accordance with the invention the portions of light which are coupled out over the length of the light guide can be emitted at an adequate level of brightness through optically active structures provided in the front side of the light guide, into the angular region which is required by legislation for side marking or riding lamps.

In that way the side flashing lamp according to the invention acquires a second function.

In accordance with a particularly preferred embodiment it is provided that further deflection structures are arranged on the rear side of the light guide in spaced relationship distributed over the length thereof and are of such a nature that they deflect the respective light portion impinging thereon, for it to issue through the front side, and in that case focus same in such a way that its spread angle approximately corresponds to that of a light emitting diode. In operation then a viewer has the impression that a plurality of individual light emitting diodes arranged at a spacing from each other are disposed distributed over the length of the light guide, the light emitting diodes emitting their light approximately in the direction of travel. The vehicle lamp according to the invention thus acquires a third function by virtue of the production of those virtual light emitting diodes.

These and other advantageous configurations of a side flashing lamp according to the invention are recited in the appendant claims.

The invention is described hereinafter by means of an embodiment by way of example with reference to the drawing in which:

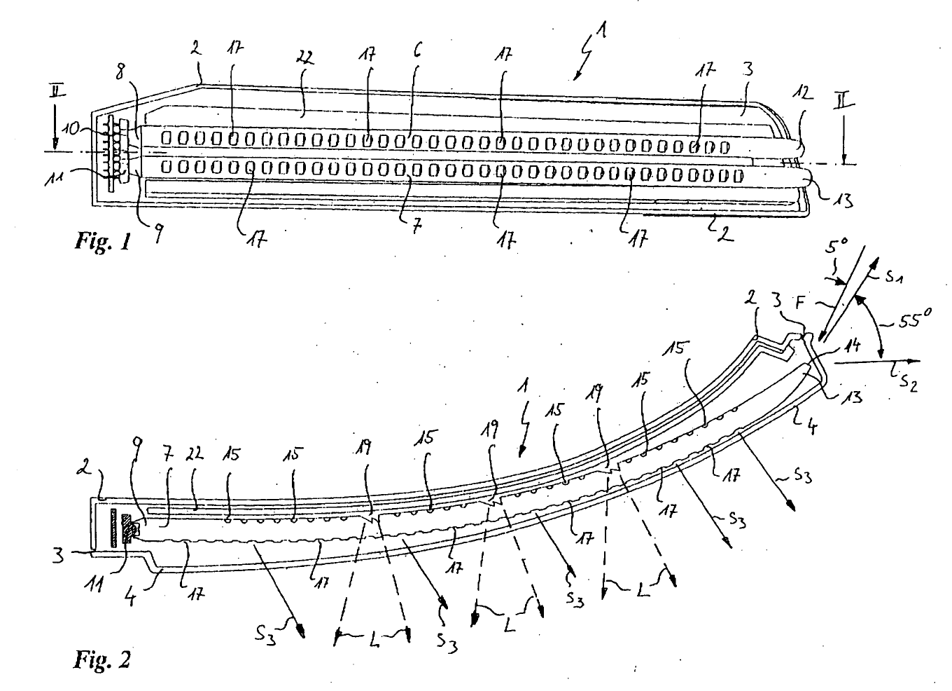

FIG. 1 is a highly diagrammatic front view of a side flashing lamp according to the invention in the installation position, viewing in the opposite direction to the direction of travel, with the light transmission cover which covers the light exit opening being omitted for the sake of clarity, and

FIG. 2 is a view in section taken along line II-II through the side flashing lamp of FIG. 1 with the light transmission cover fitted.

As can be seen from the Figures a side flashing lamp 1 according to the invention for installation in the cover cap (not shown) of an external rear view mirror in particular of a motor vehicle has a lamp housing 2 which has an elongate light exit opening 3 which in the installed condition extends substantially horizontally from the side which is at the left in the Figures and which is closer to the vehicle, towards the outside of the vehicle which is towards the right. In the assembled condition that light exit opening 3 is covered by a light transmission cover 4 (see FIG. 2).

Disposed in the interior of the housing are two bar-shaped light guides 6 and 7 which are approximately of the same length as the light exit opening 3 and which in the installed condition extend approximately horizontally thereover in such a way that their front side which faces towards the light transmission cover 4 is visible through the light transmission cover 4.

The light of a respective light source 10, 11 formed by a very bright light emitting diode is coupled into the ends 8 and 9, which are at the left in the Figures, of the light guides 6 and 7 respectively, in such a way that that light is propagated in the longitudinal direction of the light guide 6 and 7 in question to the respective end 12 and 13 thereof. That oppositely disposed end is provided in per se known manner with a bevel 14 (see FIG. 2) in such a way that the light arriving there is emitted into an angular region which in the plan view of FIG. 2 is about 550 and which is identified by the arrows S₁ and S₂, with the left boundary thereof as indicated by S₁ including an angle of about 5° with the direction of travel indicated by the arrow F in the clockwise direction. That corresponds to the light emission region which is prescribed by statutory requirements for a side flashing lamp arranged in an external rear view mirror.

As can be seen for the light guide 7 in FIG. 2, provided on the rear side of the light guides 6 and 7, which is remote from the light cover 4, are first deflection structures 15 which are arranged distributed substantially uniformly over the length of the light guides 6 and 7 and which serve to deflect the portions impinging thereon of the light which is propagated in the longitudinal direction of the light guides 6 and 7, in such a way that they issue through the front sides of the light guides towards the light transmission cover 4 and pass outwardly therethrough.

Optically active structures 17 are provided in the front side of each light guide 6 and 7, in the form of window-like notches which emit the light passing through them at the intensity required by the legislation for side marking or riding lights, into a spatial region which is identified by the arrows S₃, the left boundary S₃ of which in FIG. 2 includes an angle of about 60° with the arrow S₂.

In that way a side flashing lamp according to the invention can perform a dual function, namely in a flashing mode of operation it can perform the function of a conventional side flashing lamp and in a permanent mode of operation it can perform the function of a vehicle side marking lamp.

FIG. 2 further shows that second deflection structures 19 at substantially larger spacings than the first deflection structures 15 are arranged therebetween on the rear side of each light guide 6 and 7.

The second deflection structures 19 are such that they deflect the portions impinging thereon of the light which is propagated in the longitudinal direction of the respective light guide 6 and 7, and focus it, in such a way that it issues through the front side of the light guide 6 and 7 in question with a spread angle which approximately corresponds to that of a regular light emitting diode (indicated by the arrows L). In that way, virtual light emitting diodes are produced, of which there are for example three in the present case.

In order to improve the light yield, arranged on the side of the light guides 6 and 7 which is remote from the light transmission cover 4 is a reflector screen 22 which deflects forwardly the light which issues rearwardly from the light guides 6 and 7.

1. A side flashing lamp (1) for installation in the cover cap of an external rear view mirror of a motor vehicle comprising
a lamp housing (2) having an elongate light exit opening (3) which in the installed condition extends from the side of the cover cap, which is closer to the vehicle, substantially horizontally towards the outside of the vehicle,
at least one light guide (6, 7) which is substantially of the same length as the light exit opening (3) and in the installed condition extends substantially horizontally over same, and
at least one light source (10, 11), the light of which is coupled into the end (8, 9) of the light guide (6, 7) which is closer to the vehicle in such a way that it is propagated in the longitudinal direction thereof, wherein the portion of said light arriving at the opposite end (12, 13) is emitted in a direction (S₁-S₂) extending substantially inclinedly rearwardly with respect to the direction of travel,
characterised in that
the at least one light guide (6, 7) on its rear side remote from the light exit opening (3) has a plurality of deflection structures (15) which are arranged distributed substantially uniformly over its length and which deflect the portion impinging thereon of the light propagated in the longitudinal direction of the light guide (6, 7) towards the front side of the light guide so that it issues therethrough, and
provided in the front side of the light guide (6, 7) is a plurality of optically active structures (17) which are arranged distributed substantially uniformly over the length of the light guide (6, 7) and emit a portion of the light issuing from the front side of the light guide (6, 7) into an angular region (S₂-S₃) extending transversely with respect to the direction of travel.

2. A side flashing lamp as set forth in claim 1
characterised in that the optically active structures (17) also emit a portion of the light issuing from the front side of the light guide (6, 7) into an angular region which extends inclinedly forwardly in the direction of travel.

3. A side flashing lamp as set forth in claim 1 or claim 2
characterised in that the at least one light guide (6, 7) is of a bar-shaped configuration.

4. A side flashing lamp as set forth in one of the preceding claims
characterised in that at its free end (12, 13) at which it emits the light coupled in from the light source the light guide (6, 7) is provided with a bevel.

5. A side flashing lamp as set forth in one of the preceding claims
characterised in that the light source (10, 11) is a light emitting diode.

6. A side flashing lamp as set forth in one of the preceding claims
characterised in that a vapor-deposited reflector screen (22) is arranged behind the at least one light guide (6, 7).

6. A side flashing lamp as set forth in one of the preceding claims
characterised in that further deflection structures (19) are provided on the rear side of the light guide (6, 7) and are arranged distributed over the length thereof at greater spacings than the first deflection structures (15) and focus the portion incident thereon of the light propagated in the longitudinal direction of the light guide (6, 7) and deflect it towards the front side of the light guide (6, 7) so that it issues therethrough with a spread angle (L, L) substantially corresponding to the emission angle of a light emitting diode.

7. A side flashing lamp for installation in the cover cap of an external rear view mirror of a motor vehicle comprising
a lamp housing (2) having an elongate light exit opening (3) which in the installed condition extends from the side of the cover cap, which is closer to the vehicle, substantially horizontally towards the outside of the vehicle,
at least one light guide (6, 7) which is substantially of the same length as the light exit opening (3) and in the installed condition extends substantially horizontally over same, and
at least one light source (10, 11), the light of which is coupled into the end (8, 9) of the light guide (6, 7) which is closer to the vehicle in such a way that it is propagated in the longitudinal direction thereof,
characterised in that
further deflection structures (19) are provided on the rear side of the light guide (6, 7) and are arranged distributed over the length thereof at spacings and focus the portion incident thereon of the light propagated in the longitudinal direction of the light guide (6, 7) and deflect it towards the front side of the light guide (6, 7) so that it issues therethrough with a spread angle (L, L) substantially corresponding to the emission angle of a light emitting diode.

8. A side flashing lamp as set forth in claim 7
characterised in that the portion of the light coupled into the light guide, which arrives at the end (12, 13) further away from the vehicle, is emitted in a direction extending substantially inclinedly rearwardly with respect to the direction of travel (S₁-S₂).
